(19) United States
(12) Patent Application Publication
(10) Pub. No.: US 2007/0262230 A1
(43) Pub. Date: Nov. 15, 2007

(54) Stackable mold for making block ice

(76) Inventor: Carlos Tomas McDermott JR., San Antonio, TX (US)

Correspondence Address: Robert L. McRae of Gunn & Lee, P.C., Suite 1500, 700 N. St. Mary's Street, San Antonio, TX, 78205, US

(21) Appl. No.: 11/433,660

(22) Filed: May 12, 2006

(51) Int. Cl. B28B 7/24

(52) U.S. Cl. 249/126

(57) ABSTRACT

A stackable mold for making block ice is disclosed. The bottom edges of the sidewall of the mold have stacking lips and the top edges of the sidewall have stacking ledges. The stacking ledges of a lower mold mate with the stacking lips of an upper mold, thereby allowing multiple molds to be stacked on top of one another. Guide lips along the sidewalls of the mold prevent slipping and shifting of the stacked molds. The tapered property of the molds creates space between the bottom of an upper mold and the top of a lower mold to allow airflow through the lower mold. A reinforcing lip extends along the top of the long sides for reinforcement.

### BACKGROUND OF THE INVENTION

1. Field of the Invention

Applicant's invention relates to the field of ice molds, and more specifically to a block ice mold that is stackable directly on another like block ice mold. In one embodiment of the invention, the mold is of appropriate size to be placed in a residential freezer.

2. Background Information

It is common for people to use ice chests or coolers to keep food, beverages, or other items cold for extended periods of time where there is no access to a refrigerator or freezer. Whether on a camping trip, river trip, picnic, or a trip to the lake or beach, people pack their food, drinks, and other various items in their ice chests before heading out on their adventures. Most people use ice cubes from their freezer, or buy bags of ice from the store to keep the food and drink cold.

The common problem associated with the use of ice cubes in an ice chest is that the ice melts rapidly due to the small size of the ice cubes. This obviously can cause a variety of problems. For instance, the temperature inside the ice chest will rise as the ice melts, and water is produced more quickly due to the accelerated melting rate of the ice cubes. Because block ice melts at a slower rate, it has a longer and more sustained cooling effect and produces water at a slower rate, and thus is more desirable than cube ice.

Many people freeze water in various containers to create solid blocks of ice. For example, many people freeze water in a one gallon milk container or two liter soda bottle. Due to the unique shape of these containers, once the water is frozen inside the container, it is impossible to remove the solid block of ice from the container. Thus, the whole container must be placed in the ice chest.

One problem associated with making block ice with such containers is that ice melts on its outer surface. Therefore, as the ice in the milk or soda container melts, the surface area of the ice gets smaller. As the ice gets smaller, it concentrates toward the center of the container. Eventually, the ice no longer contacts the surface of the container. Thus, the ice is no longer in contact with the items to be kept cold.

Furthermore, due to the fact that water expands as it freezes, these containers can easily break either while the water is freezing, or if dropped or mishandled during transportation. When the plastic container is broken, it can create sharp surfaces that may injure the handler.

There exists in the prior art molds for commercial use. Some commercial block ice molds are not designed to sit horizontally, as the present invention is designed, but rather to sit upright. Moreover, due to the large size of commercial molds, the freezing time in these containers is considerably lengthy. The molds are also not stackable and cannot be used in a residential setting. There also exists in the prior art molds for residential use. One such mold employs a cumbersome rack and floor panel system to stack multiple molds. The molds are not stackable directly on top of one another.

U.S. Pat. No. 230,318 to Miller is an old patent involving a method of freezing water into blocks of ice. This patent discloses the use of a tank that holds about one hundred pounds of water. The tank is made of sheet metal and rests on a horizontal frame. Surrounding the tank are vertical frames that hold the tank in place. After the tank is filled and chilled, a thin layer of ice forms along the periphery, creating a shell. As this shell thickens enough to hold the water inside, the tank and the frames are removed, and freezing continues until the rest of the water freezes.

U.S. Pat. No. 1,380,933 to Smith is another old patent that discloses a method and apparatus for producing ice. This invention utilizes containers of different sizes to speed up the freezing process. These containers are made of iron and are tapered to facilitate removal of the ice block. The small container is filled with water and chilled until the water is completely frozen. The ice is then removed from that container and placed in the center of the big container. The big container is filled with water and chilled until frozen. The freezing time is reduced because the center of the ice block, which usually freezes last, is already frozen.

U.S. Pat. Nos. 4,498,595 and 4,601,174 to Wilson describe an apparatus and method for making and storing ice blocks. These patents disclose a system for making large blocks of ice. The containers are opened on the top and are made of rubber or plastic. These patents also disclose that the system is for making ice blocks in the home.

The patents to Wilson use a cumbersome rack and floor panel system to stack a plurality of containers. One container is filled with water and placed on the floor of the freezer. A wire support rack, which is generally shaped as a truncated pyramid, surrounds the container. A floor panel is placed on top of the wire support rack, and another container is filled with water and placed on the floor panel. The molds are not stackable directly on top of one another. The ice blocks produced from the containers are described as being between ten and fifty pound blocks.

U.S. Design Pat. No. 22,298 to Smith claims an ice mold as disclosed and shown. U.S. Design Pat. No. 191,552 to Davis claims an ornamental design for an ice tray, as shown. Finally, U.S. Design Pat. No. 277,965 to Terwilliger claims an ornamental design for a freezer tray, substantially as shown and described.

The present invention is different than the prior art. None of these patents disclose stackable molds for making block ice such as the present invention discloses. The prior art does not allow for multiple molds to be stacked directly on top of one another. The prior art does not disclose a mold that resists bowing or cracking as water freezes, as the present invention teaches. Finally, the prior art does not disclose a stackable mold of appropriate sizes to be used in a residential freezer, such as one embodiment of the present invention teaches.

It is therefore desirable to have a mold for making block ice that is large enough to sufficiently chill contents in an ice chest for long periods of time. It is further desirable for the mold to resist bowing or cracking during the freezing process. It is also desirable to have a mold that is directly stackable on top of another mold, while still allowing airflow through the lower molds to allow for efficient freezing of water in to blocks of ice in multiple molds.

### SUMMARY OF THE INVENTION

It is an object of the present invention to provide a novel mold for making blocks of ice.

It is another object of the present invention to provide a novel mold that can be stacked directly on top of another mold.

It is another object of the present invention to provide a novel mold that resists bowing or cracking during the freezing process.

It is another object of the present invention to provide a novel mold that is slightly tapered toward the bottom. The slight taper of the mold facilitates removing the block of ice from the mold. The taper also allows for the stacking of multiple molds, and provides a space for the conduction of cold air between multiple molds.

It is another object of the present invention to provide a novel stackable mold that maintains proper alignment of multiple molds on top of one another. The method uses an interaction of guide lips, stacking lips, and reinforcing lips to stack multiple molds in a way that allows airflow between the multiple units, and prevents movement or shifting of the multiple molds.

It is another object of the present invention to provide a novel mold for making blocks of ice that is of suitable size to be placed in a residential freezer.

In satisfaction of these and related objectives, a stackable mold for making block ice is disclosed. The mold of the present invention has a sidewall. In one embodiment the sidewall is comprised of panels. The panels are connected and are generally rectangular in shape, with two parallel long sides and two parallel short sides. However, the sidewall can take other shapes, such as rounded or generally oval. Handles are located on the short sides of the mold to facilitate transportation of the mold and removal of the block ice from the mold.

The mold is also tapered toward the bottom to facilitate removal of the block ice from the mold, and to allow air to flow through a lower mold when multiple molds are stacked on top of one another. The bottom surface of the mold is flat. The top of the mold is open.

The mold of the present invention also allows the user to make multiple blocks of ice by stacking multiple molds on top of one another without fear of shifting or displacement of a top mold with respect to the underlying mold. The tapered property of the mold creates gaps between stacked molds to allow air flow through the lower molds, thereby facilitating efficient freezing of water.

The mold of the present invention has a reinforcing lip extending along the periphery of the mold. The reinforcing lip is located near the top edge of the mold on the external surface of the sidewall. The reinforcing lip extends in a horizontal plane away from the mold. The reinforcing lip extends along the length of the long sides, around the corners where the long sides and the short sides intersect, and along the short sides. By continuously extending around the periphery of the mold, the reinforcing lip reinforces the mold and adds strength to the mold to prevent the sidewall from bowing, or the corners of the sidewall from cracking as water expands during the freezing process. The reinforcement provided by the reinforcing lip allows water to expand upward during the freezing process instead of laterally or outward.

Guide lips extend along the tops of the long sides. The guide lips extend upward in the same vertical plane as the long sides. The guide lips extend along the lengths of the long sides, ending at the intersections of the long sides with the short sides of the sidewall. The guide lips of the long sides are perpendicular to the reinforcing lip, and intersect the inner edge of the reinforcing lip. The guide lips on the long sides of a lower mold prevent substantial back and forth shifting of a mold stacked on top.

Guide lips extend along the tops of the short sides as well. These guide lips are formed by the inner surfaces of the handles. The guide lips of the short sides are perpendicular to the reinforcing lip and are spaced from the reinforcing lip. These guide lips extend along the lengths of the short sides. The guide lips on the short sides of a lower mold prevent substantial side to side shifting of a mold stacked on top.

Stacking ledges are also created by the guide lips of the short sides and the portion of the reinforcing lip along the short sides. These stacking ledges provide the stacking surfaces for the top mold. Stacking lips are located along the lower portions of the short sides. The stacking lips extend along the lengths of the short sides. The stacking lips also extend outwardly in a horizontal direction from the short sides of the molds.

The stacking lips of an upper mold mate and rest on the stacking ledges on the short sides of a lower mold, thereby allowing the stacking of multiple molds. Due to the tapering of the mold, an air gap is created between the upper edges of the long sides of the lower mold, and the lower edges of the long sides of the upper mold. This allows air to flow through the lower mold.

### BRIEF DESCRIPTION OF THE DRAWINGS

FIG. 1 is a perspective view of the preferred embodiment.

FIG. 2 is a front view of the preferred embodiment.

FIG. 3 is an end view along lines 3-3 in FIG. 2.

FIG. 4 is a cross sectional view FIG. 2 along lines 4-4.

FIG. 5 is a sectional front view of the preferred embodiment.

FIG. 6 is an enlarged sectional view of the interaction of multiple molds in the preferred embodiment.

### DETAILED DESCRIPTION OF THE PREFERRED EMBODIMENT

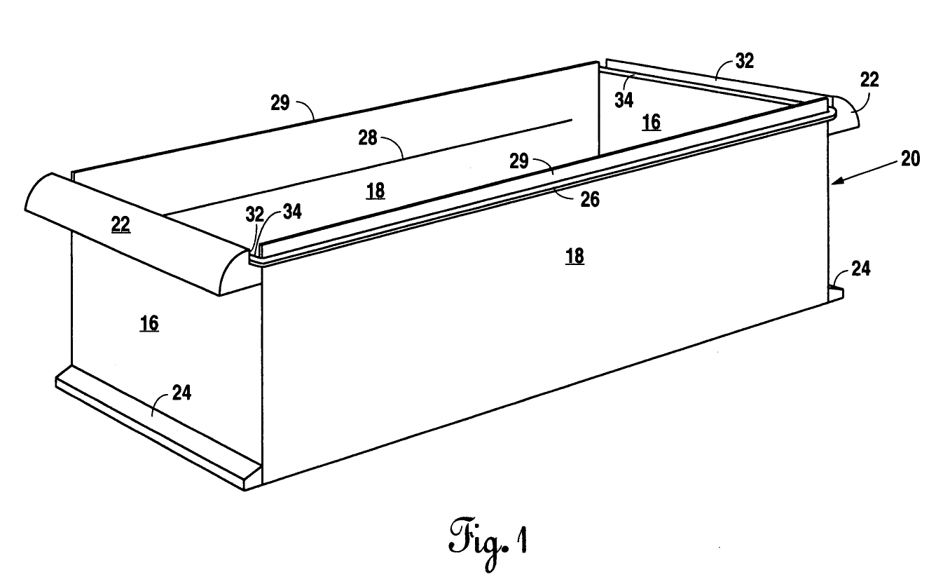

Referring to FIG. 1, the preferred embodiment for a stackable mold 20 for making block ice is disclosed. Multiple molds 20 can be stacked directly on top of one another. The mold 20 has a bottom and a sidewall. In one embodiment the sidewall is comprised of panels. The panels form a generally rectangularly shaped mold 20, with two parallel long sides 18, and two parallel short sides 16. However, the sidewall can take other shapes, such as rounded or generally oval. The bottom surface (not shown) of the mold 20 is flat. The mold 20 has an open top.

Handles 22 are located along the top edges of the short sides 16 of the sidewalls of the mold 20. Stacking lips 24 are located along the bottom edges of the short sides 16. Guide lips 32 and 29 are located on the top of the mold 20. The guide lips 29 are located on the long sides 18. The guide lips 32 are located along the short sides 16.

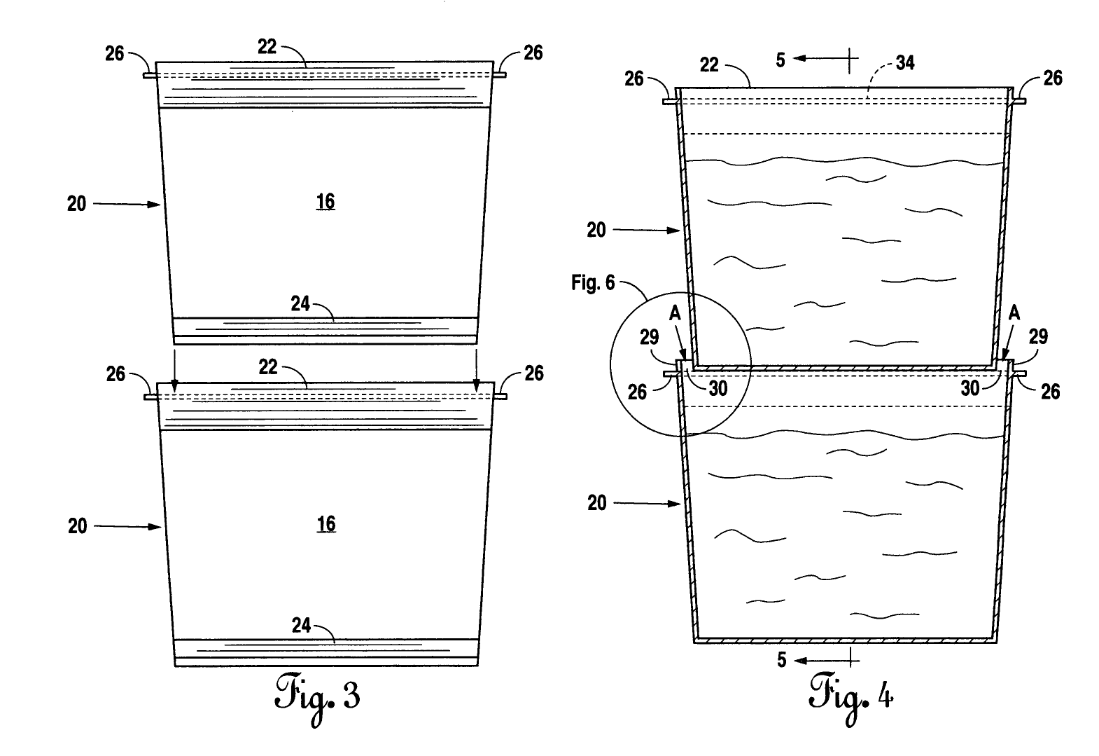

The mold 20 of the preferred embodiment is tapered toward the bottom, as best shown in FIGS. 3 and 4. When multiple molds 20 are stacked on top of one another, the tapering of the mold 20 allows air A to flow through a lower mold 20 along long side 18 through space 30. The airflow A allows the water in the lower mold to freeze while an upper mold is stacked on top of it. The tapering of the mold 20 also facilitates removal of a block of ice from the mold 20.

Referring now to FIG. 1, a reinforcing lip 26 extends along the periphery of the sidewall of the mold 20. The reinforcing lip 26 extends outward in a horizontal plane along the top of the mold 20. The reinforcing lip 26 is located on the external surface of the sidewall of the mold 20. The reinforcing lip 26 extends across the lengths of the long sides 18, continuing around the corners where the long sides 18 and the short sides 16 intersect, and continuing along the short sides 16. The reinforcing lip 26 adds strength to the mold 20 that prevents the sidewall of the mold 20 from bowing, or the corners from cracking when water expands during the freezing process. Due to the reinforcement provided by the reinforcing lip 26, water will expand upward toward the open top as it freezes.

As shown, the reinforcing lip 26 extends continuously around the periphery of the mold 20. However, in alternate embodiments, the reinforcing lip 26 extends along at least a portion of the sidewall, but is not necessarily continuous.

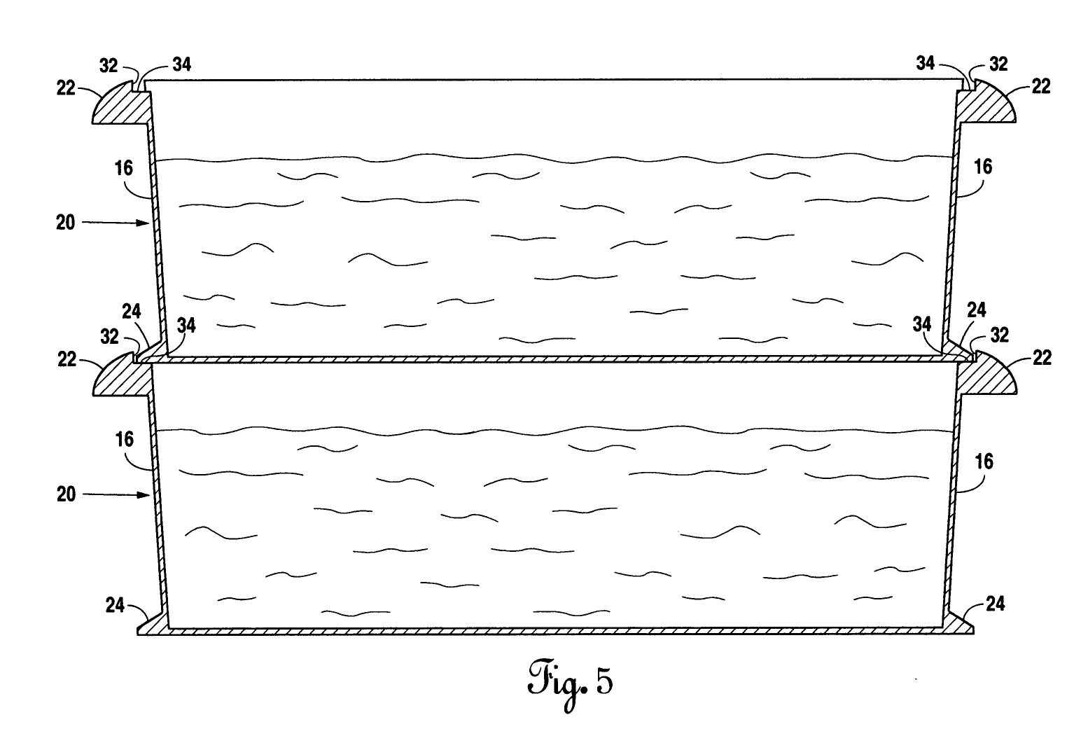

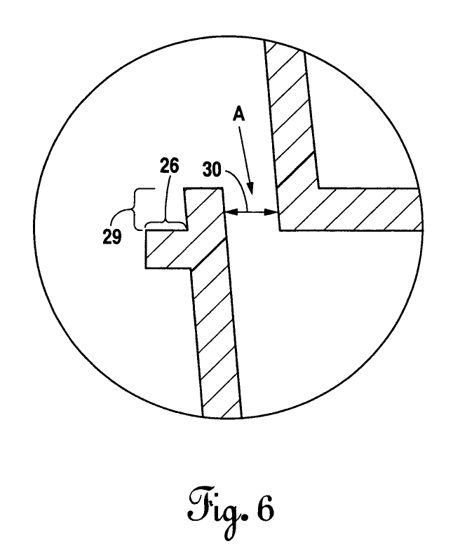

Referring now to FIGS. 1, 2 and 5, the handles 22 extend from the mold 20 along the upper portions of the external surfaces of the short sides 16 of the sidewall of the mold 20. The handles 22 extend across the lengths of the short sides 16. As best shown in FIG. 1, the inner edges of the handles 22 form the guide lips 32. The guide lips 32 extend above the mold 20. The guide lips 32 are perpendicular to the portions of the reinforcing lip 26 extending along the short side 16. The guide lips 32 are attached to the outer edge of the portions of the reinforcing lip 26 that extend along the short sides 16. The guide lips 32 and the portions of the reinforcing lip 26 that extend along the short sides 16 form stacking ledges 34 that will be discussed below.

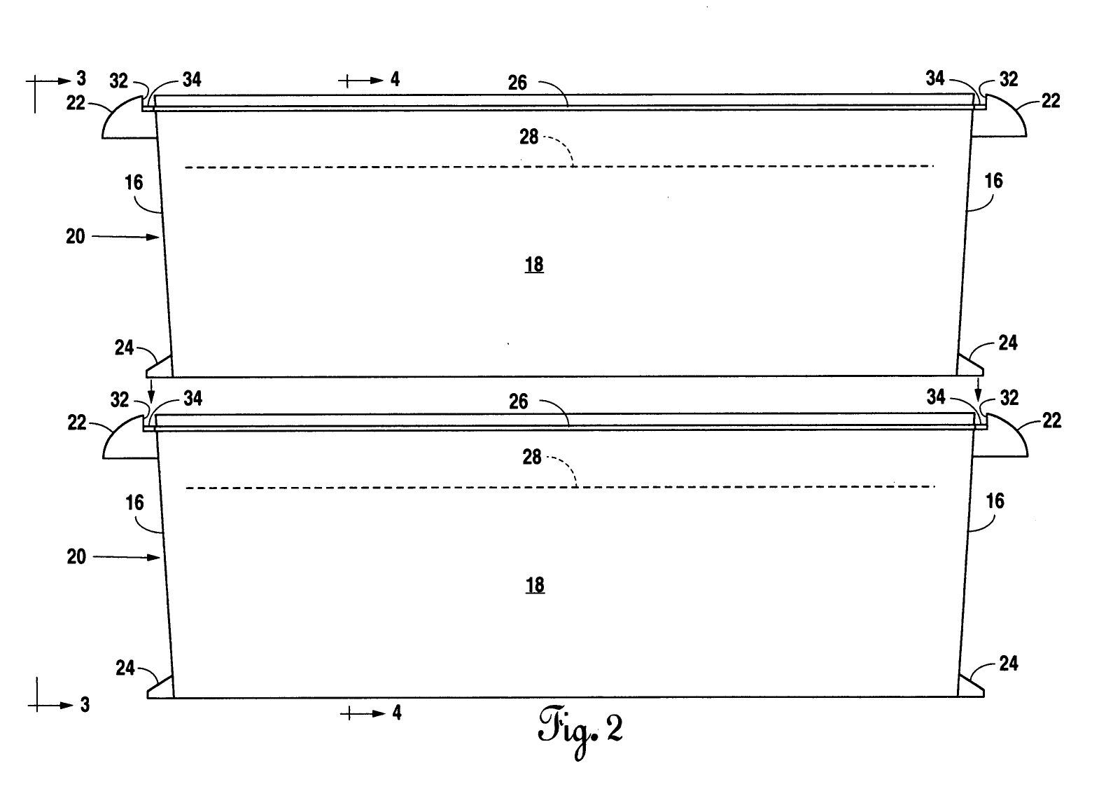

Referring to FIGS. 1 and 2, the guide lips 29 are located along the tops of the long sides 18 as well. The guide lips 29 extend along the lengths of the long sides 18, and terminate at the intersections of the long sides 18 and the short sides 16. The guide lips 29 are perpendicular to the reinforcing lip 26. The guide lips 29 intersect the inner edge of the portions of the reinforcing lip 26 that extend along long sides 18. The guide lips 29 also extend upward from the mold 20, in the same vertical plane as the long sides 18.

The stacking lips 24, as shown in FIGS. 1, 2 and 5 are located along the bottom edges of the short sides 16. The stacking lips 24 extend outward from the mold 20 along the lengths of the short sides 16. As shown in FIG. 1, the top surfaces of the stacking lips 24 extend downwardly and outwardly from the mold 20. The bottom surfaces of the stacking lips 24 rest in the same horizontal plane as the bottom (not shown) of the mold 20. The structure of the stacking lips 24 prevents sagging or bending of the mold 20 when filled with water or ice and stacked on top of another mold 20.

Finally, a water level indicia 28 is located on the sidewall of the mold 20. The water level indicia can be located on the interior or exterior surface of either the long side 18 or short side 16 of the sidewall of the mold 20. As the water in the mold 20 freezes, it expands upward toward the open top. Over filling the mold 20 with water will cause water to spill as the freezing process occurs. Furthermore, over filling a lower mold 20 can cause the frozen water to stick to an upper mold 20. Therefore, the water level indicia 28 is located at an appropriate level to account for the expansion of the water upward as it freezes, preventing spilling of water or freezing to an upper mold 20.

Referring to FIGS. 2 through 6, when stacking multiple molds 20, by resting the stacking lips 24 on the stacking ledges 34, the bottom surface of the upper mold 20 is sufficiently raised above the lower mold 20 to prevent contact with the water in the lower mold 20, and allow air to flow through the lower mold 20. Furthermore, because the mold 20 is tapered toward the bottom, a gap 30 exists between the upper and lower molds 20. The gap 30 allows air to flow through the lower mold 20, as best shown in FIGS. 4 and 6. The movement of air allows water in the lower mold 20 to freeze into block ice while an upper mold 20 rests on top of it.

The guide lips 32 on the short sides 16 of the lower mold 20 prevent the upper mold 20 from substantially shifting from side to side. Likewise, the guide lips 29 on the long sides 18 of the lower mold 20 likewise prevent the upper mold 20 from substantially shifting back and forth. Thus, the guide lips 29 and 32 aid in aligning an upper mold 20 to a lower mold 20 and preventing the upper mold 20 from slipping off of the lower mold 20.

When the water is frozen into blocks of ice and ready for use, the user removes a mold 20 from the freezer, places the open top of the mold 20 in a downward direction. The user then applies warm tap water until the block of ice releases from the mold 20. Thus, present invention should be made from materials that will withstand extremely cold temperatures and quick transitions between cold and hot temperatures. Furthermore, because water expands as it freezes into ice, the present invention must be made of materials that will not crack or break during the freezing process. It is contemplated that the preferred embodiment of the invention can be made from a polyurethane polymer, or similar polycarbamate. However, other suitable materials with the characteristics described above may be used.

One embodiment of the present invention is described as being of appropriate dimensions to fit in a typical residential freezer. In this embodiment, it is suggested that the width and height of the mold 20 are generally considered to be in a range from approximately four inches to approximately eight inches, and the length of the mold 20 is considered to be in the range of six to sixteen inches. It is also suggested that molds 20 of such dimensions yield blocks of ice ranging from less than three pounds to approximately thirty pounds. However, it is to be understood that a mold for residential use is only one embodiment of the present invention. These sizes are for purposes of illustration only, and are not considered to limit the present invention in any manner. Other sizes may be used and are contemplated by the present invention.

Furthermore, although shown in a generally rectangular shape, it is also anticipated that other shapes are acceptable. For instance, the mold 20 could be generally square or cubed shaped, with equal length axes, or generally circular in shape.

A stackable mold 20 for making block ice has been disclosed and described. Although the invention has been described with reference to specific embodiments, this description is not meant to be construed in a limited sense. Various modifications of the disclosed embodiments, as well as alternative embodiments of the invention will become apparent to persons skilled in the art upon the reference to the description of the invention. It is, therefore, contemplated that the appended claims will cover such modifications that fall within the scope of the invention.

I claim:

1. A stackable mold for making block ice comprising:
a sidewall having a top edge and a bottom edge;
a bottom connected to said bottom edge of said sidewall and cooperating with said sidewall to form an open top mold;
a stacking lip extending outwardly from at least a predefined portion of said sidewall at a position adjacent the bottom edge of said sidewall; and,
a reinforcing lip extending outwardly from at least a portion of said sidewall at a position adjacent the top edge of said sidewall and in parallel relationship with said top edge.

2. A stackable mold for making block ice, as set forth in claim 1, wherein said bottom of the mold has an area less than that of the open top of the mold such that when one of said stackable molds is stacked upon another one of said stackable molds, the stacking lip of an upper mold is supported by at least a portion of said reinforcing lip of a lower mold.

3. A stackable mold for making block ice, as set forth in claim 2, wherein said stackable mold further comprises a guide lip extending above said reinforcing lip such that when one of said stackable molds is stacked upon another one of said stackable molds, the guide lip provides a guide for said sidewall and said stacking lip of an upper mold to provide proper alignment of said upper mold with the lower mold.

4. A stackable mold for making block ice, as set forth in claim 3, wherein said mold includes a handle extending outwardly from said predefined portion of the sidewall at a position adjacent the top edge of the sidewall.

5. A stackable mold for making block ice, as set forth in claim 4, wherein said handle has a guide lip parallel to and spaced from said predefined portion of the sidewall.

6. A stackable mold for making block ice, as set forth in claim 1, wherein said mold includes a handle extending outwardly from said predefined portion of the sidewall at a position adjacent the top edge of said sidewall.

7. A stackable mold for making block ice, as set forth in claim 6, wherein said handle has a guide lip parallel to and spaced from said predefined portion of the sidewall.

8. A stackable mold for making block ice, as set forth in claim 1, wherein said sidewall comprises four planar panels joined together to form a continuous generally rectangularly shaped sidewall.

9. A stackable mold for making block ice, as set forth in claim 1, wherein the mold includes a predefined water level indicia on the sidewalls, said predefined water level indicia being spaced from the top edge of the sidewall at a distance sufficient to prevent water when frozen in the mold to extend above said top edge of the sidewall.

10. A stackable mold for making block ice, as set forth in claim 9, wherein said predefined water level indicia is spaced from the top edge of the sidewall at a distance sufficient to prevent water when frozen in the mold from contacting the bottom of an adjacent vertically stacked mold as defined herein.

11. A stackable mold for making block ice comprising:
a sidewall having a top edge, a bottom edge, and four generally planar panels, said panels being joined together to form a generally rectangularly shaped cavity;
a bottom connected to said bottom edge of the sidewall and cooperating with said sidewall to form an open top mold;
a stacking lip extending outwardly from at least a predefined portion of said sidewall at a position adjacent the bottom edge of the sidewall; and,
a reinforcing lip extending outwardly from at least a portion of the sidewall at a position adjacent the top edge of said sidewall and in parallel relationship with said top edge;

12. A stackable mold for making block ice, as set forth in claim 11, wherein said bottom of the mold has an area less than that of the open top of the mold such that when one of said stackable molds is stacked upon another one of said stackable molds, the stacking lip of an upper mold is supported by at least a portion of said reinforcing lip of a lower mold.

13. A stackable mold for making block ice, as set forth in claim 12, wherein said stackable mold further comprises a guide lip extending above said reinforcing lip such that when one of said stackable molds is stacked upon another one of said stackable molds, the guide lip provides a guide for the sidewall and said stacking lip of an upper mold to provide proper alignment of said upper mold with the lower mold.

14. A stackable mold for making block ice, as set forth in claim 13, wherein said mold includes a handle extending outwardly from a predefined portion of the sidewall at a position adjacent the top edge of the sidewall.

15. A stackable ice mold for making block ice, as set forth in claim 14, wherein said handle has a guide lip parallel to and spaced from said predefined portion of the sidewall.

16. A stackable mold for making block ice, as set forth in claim 11, wherein said mold includes a handle extending outwardly from said predefined portion of the sidewall at a position adjacent the top edge of said sidewall.

17. A stackable mold for making block ice, as set forth in claim 16, wherein said handle has a guide lip parallel to and spaced from said predefined portion of the sidewall.

18. A stackable mold for making block ice, as set forth in claim 11, wherein the mold includes a predefined water level indicia on the sidewall, said predefined water level indicia being spaced from the top edge of the sidewall at a distance sufficient to prevent water when frozen in the mold to extend above said top edge of the sidewall.

19. A stackable mold for making block ice, as set forth in claim 18, wherein said predefined water level indicia is spaced from the top edge of the sidewall at a distance sufficient to prevent water when frozen in the mold from contacting the bottom of an adjacent vertically stacked mold as defined herein.
